(19) United States
(12) Patent Application Publication
(10) Pub. No.: US 2026/0295541 A1
(43) Pub. Date: Oct. 1, 2026

(54) PILLARED CLAY MINERAL MEMBRANES

(71) Applicants: UCHICAGO ARGONNE, LLC, Chicago, IL (US); THE UNIVERSITY OF CHICAGO, Chicago, IL (US)

(72) Inventors: Seth B. DARLING, Berwyn, IL (US); Yining LIU, Lombard, IL (US)

(73) Assignees: UCHICAGO ARGONNE, LLC, Chicago, IL (US); THE UNIVERSITY OF CHICAGO, Chicago, IL (US)

(21) Appl. No.: 19/461,541

(22) Filed: Jan. 27, 2026

Related U.S. Application Data
(60) Provisional application No. 63/779,076, filed on Mar. 27, 2025.

(51) Int. Cl. B01D 71/02; B01D 67/00; B01D 69/02

(52) U.S. Cl. CPC B01D 71/027; B01D 67/0044; B01D 67/0076; B01D 69/02; B01D 2325/06

(57) ABSTRACT

A two-dimensional membrane and methods of producing the membrane are provided. The membrane includes a phyllosilicate material including at least one clay mineral and a plurality of pillars. The phyllosilicate material forms two or more phyllosilicate layers of the membrane and each of the layers are separated by the plurality of pillars. The plurality of pillars include a metal and are bonded to the phyllosilicate material. The method includes providing a phyllosilicate material including a clay mineral and exfoliating the phyllosilicate material into a plurality of flakes. The method includes combining the pillaring precursor with the plurality of flakes. The plurality of flakes are restacked to form a membrane including at least two phyllosilicate layers with the pillaring precursor disposed therebetween. The method includes calcinating the membrane to form a pillared membrane.

### CROSS-REFERENCE TO RELATED APPLICATION

This application claims priority to U.S. Provisional Patent App. No. 63/779,076 filed Mar. 27, 2025, the contents of which is incorporated herein by reference in its entirety.

### STATEMENT OF GOVERNMENT INTEREST

This disclosure was developed using government support under Contract No. DE-AC02-06CH11357 awarded by the United States Department of Energy to UChicago Argonne LLC, operator of Argonne National Laboratory.

### TECHNICAL FIELD

The present disclosure relates generally to membranes, and methods of producing the same. More specifically, the present disclosure relates to pillared clay mineral membranes and methods of producing the same.

### BACKGROUND

Laminar membranes can be implemented in a variety of use applications including, but not limited to, water filtration, organic solvent nanofiltration, biotechnology, and resource recovery. Water stability, ion-selectivity, and other factors can limit effectiveness and longevity of a membrane.

### SUMMARY

At least one embodiment relates to a two-dimensional membrane. The membrane includes a phyllosilicate material including at least one clay mineral. The phyllosilicate material forms two or more phyllosilicate layers of the membrane. Each of the two or more phyllosilicate layers are separated by a plurality of pillars. The membrane includes the plurality of pillars including a metal and bonded to the phyllosilicate material.

At least one embodiment relates to a method of producing a two-dimensional membrane. The method includes providing a phyllosilicate material. The phyllosilicate material includes a clay mineral. The method includes exfoliating the phyllosilicate material into a plurality of flakes and combining pillaring precursors with the plurality of flakes. The plurality of flakes are restacked with the pillaring precursors to form a membrane including at least two phyllosilicate layers with the pillaring precursors disposed therebetween. The phyllosilicate layers include the plurality of flakes. The method includes converting the pillaring precursors to pillars to form the two-dimensional membrane as a pillared membrane.

At least one embodiment relates to a method of producing a membrane. The method includes exfoliating a phyllosilicate material. The phyllosilicate material includes a clay mineral. The method includes combining a pillaring precursor with the exfoliated phyllosilicate material and restacking the pillaring precursor with the exfoliated phyllosilicate material to form the membrane. The membrane includes two phyllosilicate layers with the pillaring precursor disposed therebetween. Each of the phyllosilicate layers includes the phyllosilicate material.

This summary is illustrative only and should not be regarded as limiting. It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE FIGURES

A clear conception of the advantages and features constituting the present disclosure, and of the construction and operation of typical mechanisms provided with the present disclosure, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a schematic representation of a two-dimensional membrane, according to at least one embodiment.

FIG. 2 is a schematic representation of a process of forming a pillared clay mineral membrane, according to at least one embodiment.

FIG. 3 is a perspective view of a pillared clay mineral membrane, according to at least one embodiment.

FIG. 4 is a schematic representation of a process of forming a pillared clay mineral membrane, according to at least one embodiment.

FIG. 5 is method of forming a pillared clay mineral membrane, according to at least one embodiment.

FIG. 6A shows images of pillared and not pillared clay mineral membranes. FIG. 6B is a graphical representation of water stability for dry and wet pillared clay mineral membranes.

FIG. 7 is a graphical representation of surface charge for clay mineral membranes, represented by zeta potential.

FIG. 8 is a graphical representation of pore size indicated by water permeance for clay mineral membranes.

FIG. 9A is a graphical representation of salt permeability for diamine cross-linked vermiculite membranes. FIG. 9B is a graphical representation of salt permeability for pillared vermiculite membranes.

FIG. 10A is a graphical representation of salt permeability for diamine cross-linked vermiculite membranes. FIG. 10B is a graphical representation of salt permeability for pillared vermiculite membranes.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

As indicated above, membrane technologies can be extensively applied to several applications including water filtration, organic solvent nanofiltration, and extraction of valuable resources. Several types of membranes using a variety of materials have been investigated. However, fouling, permeability-selectivity trade-off, high energy input to process, cost, and scalability can limit use and/or longevity.

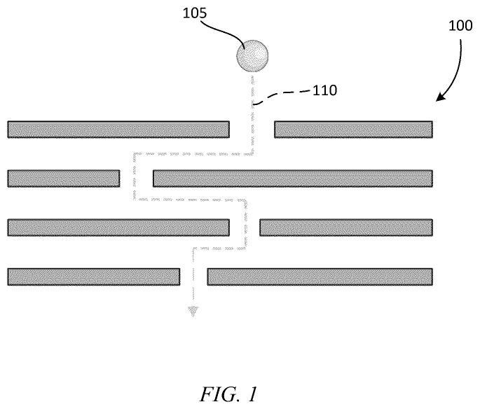

FIG. 1 is a schematic representation of a two-dimensional (2D) membrane 100. In various embodiments, 2D membranes (e.g., the 2D membrane 100) can be formed by restacking 2D material flakes into laminates. A stacking pattern of the 2D membrane is synonymous regardless of a number of layers or a thickness of the membrane, such that the formed membrane is a 2D membrane formed from 2D material flakes. In various embodiments, the 2D material flakes can be restacked using vacuum filtration. In other embodiments, the restacking is achieved using slot-die or blade coating. The resulting 2D interlayer galleries provide permeation paths (e.g., permeation path 110) throughout one or more channels for the transport of ions and/or water molecules and/or organic molecules 105. In various embodiments, the size of the one or more channels and/or the chemical properties of 2D membranes can be tuned by modifying the molecular interaction and surface chemistry of the 2D materials. Adjusting the channel size and/or tuning the chemical properties of the 2D membranes can enable membrane use in one or more targeted applications. Various 2D materials have been studied for membrane applications, such as graphene oxide (GO), transitional metal dichalcogenides (TMDs), and MXenes. However, for these widely investigated 2D materials, there remain challenges that impact their use including, but not limited to, laborious surface modifications, poor water stability, and/or high material cost.

Phyllosilicates are a type of 2D material. Phyllosilicates are a group of minerals with a sheet-like (e.g., 2D) structure. Phyllosilicate materials, which have been traditionally used in industrial applications, are typically used in bulk form as they tend to be available in abundance and cost less in comparison to other 2D materials. Clay minerals include different types of phyllosilicates which are naturally occurring 2D materials with layered structures that can be easily exfoliated and restacked to form membranes. There are over 40 different types of phyllosilicates including smectite, vermiculite, kaolinite, and mica, which are distributed globally and at low cost in comparison to other materials. For example, the global production for montmorillonite (MMT), a type of smectite, was approximately 19 million tons in 2022, averaging about $97 per ton. Phyllosilicate minerals form a 2D layered structure, where each layer can include various combinations of silica tetrahedral sheets and alumina octahedral sheets. Each phyllosilicate mineral can have its own unique combination of physical and chemical properties including, but not limited to, flake morphology, layer charge, cation species, and chemical reactivity. Accordingly, the functional versatility of phyllosilicates by combining the strengths of different phyllosilicates from the vast clay mineral library can offer great potential for targeted applications. However, challenges such as water instability and lack of ion transport selectivity has hindered practical applications.

The water instability of clay minerals originates from their crystal structure. The 2D layers of clay minerals are formed by aluminosilicates. Isomorphic substitution occurs within these layers, leading to permanent negative charge, which is balanced by interlayer cations. The weak binding interaction between layers can be easily broken when water is present, leading to the swelling of clay minerals and poor water stability. Previous reports on increasing the binding strength between layers (primarily from our own group) are only through electrostatic interactions, which are weaker than covalent bonding and may lack long-term stability. The systems and methods described herein offer a more robust and stable approach by using a pillaring precursor and calcination to form covalent bonds between the layers of clay minerals, therefore increasing the water stability.

Research concerning phyllosilicate mineral membranes has included catalytic, electronic, and energy applications. However, as described above, there is a lack in research concerning membrane separation using phyllosilicates, which has left issues of water stability and lack of ion selectivity unsolved. Due to the weak interlamellar interactions, some phyllosilicates can gradually swell in water, leading to uncontrollable interlayer properties and structural breakdown of the membrane. Water instability can be addressed using various methods, such as surfactant intercalation or silicone rubber sealing; however, these methods can be accompanied by long-term stability issues due to unaffected interlamellar attraction.

Previous reports have included crosslinking phyllosilicate membranes with diamine. However, as described, binding through electrostatic interaction is weaker, resulting in water instability and swelling in water. Additionally, ion selectivity between certain ions (e.g., monovalent cations) is not optimal for practical application. The systems and methods described herein discuss the formation and use of pillared clay mineral membranes with laminar structure. The pillared clay mineral membranes have covalent bonds between layers resulting in a more stable membrane when compared to previous cross-linked phyllosilicate membranes. Additionally, the broad library of clay minerals and pillaring precursor that can be used for the pillared clay mineral membranes offers a wide combination of membranes that can be created dependent on desired performance of the membrane. Nevertheless, a universal method for pillared clays for selective ion transport has not been explored for phyllosilicate membranes. Accordingly, it would be advantageous to combine the strengths of a diverse library of clay minerals and pillaring precursors with ion transport selectivity to improve phyllosilicate membrane performance for use in a multitude of practical applications.

Referring generally to the figures, various embodiments relate to pillaring various phyllosilicates that contain clay minerals with a pillaring precursor to improve water stability and ion or molecule selectivity, such as in membranes. The usage of pillared clays for laminar membranes allows for greater tunability as the systems and methods described herein can be applied to different pillars and different clays. The resultant membrane is a pillared clay mineral membrane. In various embodiments, a cation doping modification can be applied to achieve an increase in ion selectivity. As such, the pillared clay mineral membrane can be fabricated from a diverse library of clay minerals and pillars, while keeping the general fabrication process the same. Additionally, for embodiments where the resultant membrane is fully inorganic, it is possible to tune ion sieving performance by doping cations. This is in stark comparison to the possibilities in comparison to other 2D membranes, where surface functionalization or other complex process are needed to tune membrane ion sieving performance.

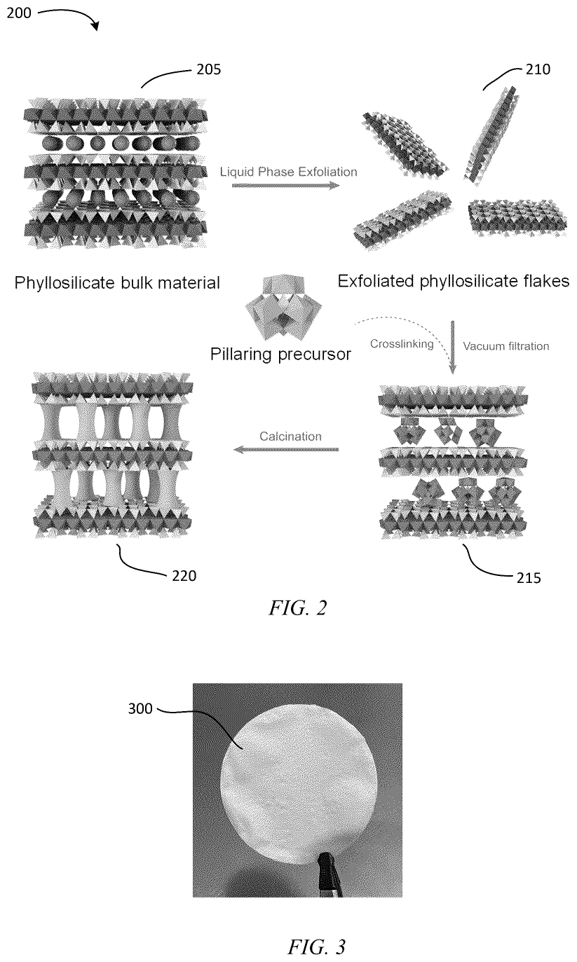

FIG. 2 is a diagram that illustrates a process 200 of forming a pillared clay mineral membrane, according to an exemplary embodiment. A mineral material is provided at step 205. In various embodiments, the mineral material is a phyllosilicate bulk material. In various embodiments, the mineral material is a clay mineral. The clay minerals can include a wide variety such as vermiculite, mica, and montmorillonite, among others. As described herein, the diverse library of clay minerals provides a wide range of physical and/or chemical properties for the resultant pillared clay mineral membrane dependent on the clay mineral used.

As shown in FIG. 2, the phyllosilicate bulk material is exfoliated at step 210. For example, the clay mineral material is exfoliated. The exfoliation of the phyllosilicate bulk material forms exfoliated phyllosilicate flakes. Exfoliation allows for a stable dispersion of 2D flakes to be created as interlayers of the clay mineral material are gradually expanded. In various embodiments, clay mineral is exfoliated to produce a stable colloid dispersion of clay mineral 2D flakes. Preferably, after exfoliation, the produced 2D flakes are monolayer. However, it may be difficult to thoroughly exfoliate all the material such that the 2D flakes are all monolayer. In such embodiments, small aggregates with few layers (e.g., less than ten layers) may be produced. The exfoliated 2D flakes may include both monolayers and flakes with few layers. A lateral size of the 2D flakes may vary depending on the phyllosilicate material and exfoliation process. However, smaller lateral sizes (e.g., <100 nanometers) may lead to defects in formation and transport through voids between the flakes rather than the membrane interlayers.

In various embodiments, liquid phase exfoliation is conducted to exfoliate the phyllosilicate bulk material at step 210. Although liquid phase exfoliation is described, it can be appreciated by those skilled in the art that a number of exfoliation methods, such as electrochemical exfoliation and shear exfoliation may be used. Liquid phase exfoliation of the phyllosilicate bulk material (including mineral materials, clay minerals, etc.) can include refluxing the material with a salt solution (e.g., a saturated salt solution). In some embodiments, the material can be refluxed with more than one salt solution. For example, the material may be refluxed with sodium chloride and lithium chloride. The material can be refluxed with a first salt solution, followed by reflux with a second salt solution. In other embodiments, the first salt solution includes a first salt having a first size and the second salt solution includes a second salt with a second size. The second size may be greater than the first size. In various embodiments, using a first and second salt solution where the corresponding second size is greater than the first size can increase layer spacing (e.g., like a wedge) such that agitation (e.g., via ultrasonication) of the mineral material can cause complete exfoliation. In various embodiments, refluxing the mineral material in the salt solution is carried out for a period of time. For example, the period of time may be at least 24 hours. In various embodiments, the mineral material is agitated for complete exfoliation. For example, sonication and ultrasonication, among others, may occur in order to agitate the mineral material. The use of clay minerals offers a sustainable way of processing as exfoliation of clay minerals may only require refluxing with salt solution.

As described, the exfoliation of the phyllosilicate bulk material forms exfoliated flakes. A pillaring precursor can then be added to the exfoliated flakes at step 215. The pillaring precursor is configured to create pillared clay such that the end result is a pillared mineral membrane. The pillaring precursor can be a polycation containing aluminum, zirconium, titanium, and other metal cations, among others. For example, the pillaring precursor may be a Al₁₃ materials such as polyhydroxy-aluminum. Similarly, the pillaring precursor may be a Zr-oligomer species such as [Zr₄(OH₈(H₂O)₁₆]⁸⁺ cation. A third example pillaring precursor is titanium isopropoxide. The polycation used and its corresponding chemical composition may affect layer formation of the membrane and functionality of the membrane. As a result, the membrane may be dependent on the pillaring precursor (e.g., the polycation) used. In various embodiments, the pillaring precursor is synthesized. For example, the pillaring precursor may be synthesized by adding a base into a salt solution that contains a metal cation. In various embodiments, the base is sodium hydroxide. The metal cation can be a same type as a metal cation in the final metal oxide pillar. In the pillaring precursor fabrication, the metal cations transform into metal hydroxide polycations with Keggin structure. The pillaring precursor is added to the exfoliated clay mineral flakes and agitated. For example, sonication can occur to allow for agitation. In various embodiments, sonication is carried out for a period of time. For example, the period of time may be approximately one hour. In various embodiments, the period of time is longer than one hour. Greater sonication of the pillaring precursor with the mineral flakes can result in smaller flake sizes due to extended sonication.

The choice of clay minerals and a pillaring precursor can be optimized based on a target ion/molecule selectivity and/or a target water permeability. In various embodiments, the clay minerals and a pillaring precursor can be optimized based on a target amount of chemical reactivity, a desired layer morphology, and/or any other desired physical or chemical characteristic. In some embodiments, more than one phyllosilicate materials (e.g., clay minerals) and/or pillaring precursors can be provided.

In various embodiments, the pillared flakes of the clay mineral material and the pillaring precursor undergo a membrane-forming process at step 215. For example, the clay mineral material and the pillaring precursor may undergo vacuum filtration as shown in FIG. 2. In other embodiments, the clay mineral material and the pillaring precursor may undergo blade coating or slot-die casting, among other membrane-forming process. In vacuum filtration, the pillared flakes of the clay mineral material and the pillaring precursor is vacuum filtered onto a porous substrate and dried. In various embodiments, the pillared flakes are dried in an oven. In some embodiments, a temperature within the oven is less than 100 degrees Celsius. The material after the membrane-forming process forms a pillaring precursor intercalated laminar clay mineral membrane. As shown in FIG. 2, the membrane formed at step 215 includes two phyllosilicate layers with the pillaring precursor disposed therebetween. The membrane may include at least two phyllosilicate layers (e.g., two or more layers). In various embodiments, the formed membrane (i.e., the pillaring precursor intercalated laminar clay mineral membrane) is a free-standing membrane 300, such as shown in FIG. 3. In various implementations, the resultant membrane can be used together with a polymer or ceramic membrane support.

At step 220 of process 200, the pillaring precursors is converted to pillars. The intercalated laminar clay mineral membrane may be calcinated at step 220 to convert the pillaring precursors. The membrane is calcinated to form metal oxide pillars from the intercalated precursors. The metal oxide pillars are covalently bonded to the phyllosilicate layers (e.g., the phyllosilicate material, the clay mineral flakes). In other words, the pillars are configured to form covalent bonds with the phyllosilicate material. The covalent bonds allow for a more robust and stable mineral membrane. A weaker binding interaction between layers can be easily broken when water is present, leading to the swelling of clay minerals and poor water stability. The usage of covalent bonds between the clay mineral flakes improves usage and long-term stability in comparison to other approaches (e.g., electrostatic interactions). In various embodiments, calcination occurs at a range of temperatures. For example, the range of temperatures can be 300° C. to 500° C. During the calcination process, the precursor Keggin ion, as described in relation to formation of the pillaring precursor, is dehydrated to form metal oxide pillars, which are covalently bonded to the 2D clay mineral flakes. The calcination process forms the resultant laminar pillared clay mineral membrane. As described herein, the process 200 described herein is universal and can be applied to a wide range of combinations of clay mineral and pillaring precursors.

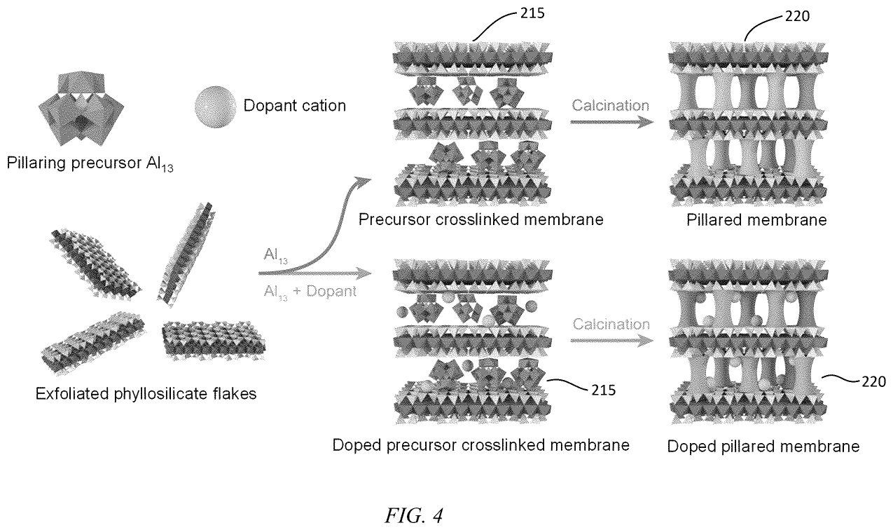

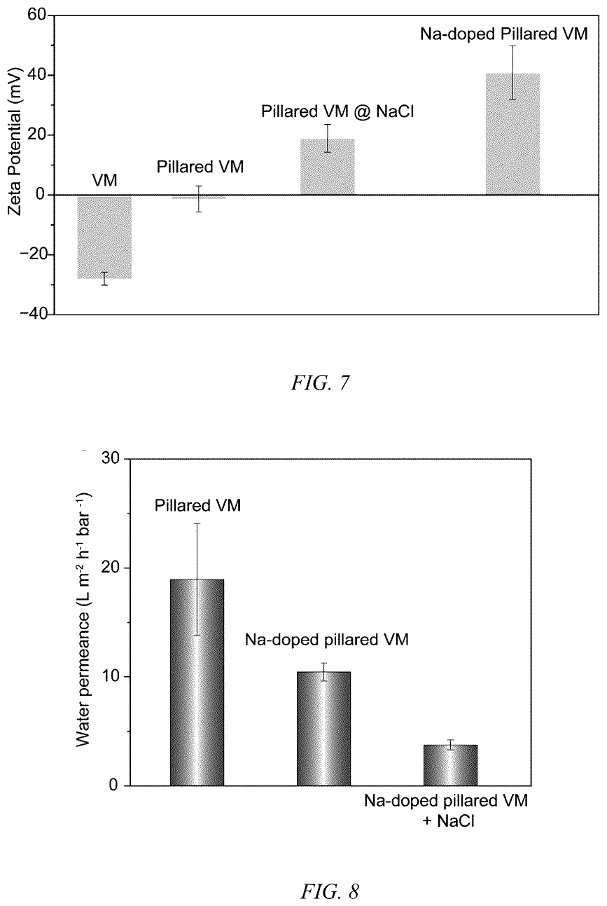

As shown in FIG. 4, in various embodiments, a cation doping modification can be added to the process (e.g., the process 200 described with reference to FIG. 2) in order to further optimize the produced pillared clay mineral membrane. Doping can occur at a number of steps in the process (e.g., the process 200) of forming the pillared clay mineral membrane. For example, doping can occur after exfoliation (e.g., after step 210), before calcination (e.g., prior to step 220), during fabrication of the pillaring precursor (e.g., during step 215), etc. As depicted in FIG. 4, a dopant cation can be added in the pillaring precursor intercalation process (e.g., step 215). As shown in FIG. 4, rather than only adding the pillaring precursor, the pillaring precursor and the dopant cation can be added a step 215. In various embodiments, doping is used to enhance ion transport selectivity. For example, sodium doped pillared laminar vermiculite membrane can be fabricated by adding excess sodium ions (the dopant cation) during the pillaring precursor intercalation. As further described herein with reference to FIGS. 7-10B, the sodium doped pillared laminar vermiculite membrane can lead to positive surface charge and increased monovalent/multivalent cation separation when compared to a pillared laminar vermiculite membrane that is not doped.

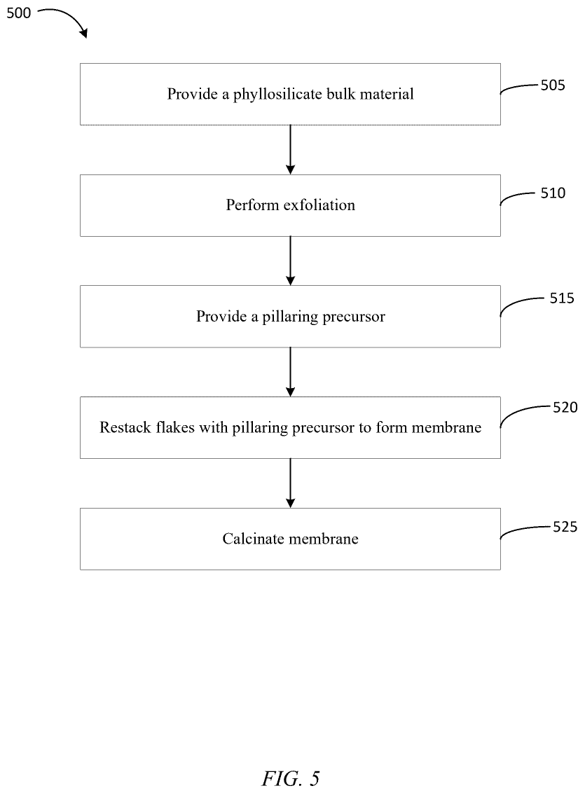

FIG. 5 shows a method 500 of forming the pillared laminar clay mineral membrane. The method 500 is universal and can be applied to substantially any combination of clay minerals and pillaring precursor. The method 500 includes providing a phyllosilicate bulk material at step 505. In various embodiments, the phyllosilicate bulk material is a clay mineral material. In various embodiments, providing the phyllosilicate bulk material at step 505 can include step 205 as described herein with reference to process 200.

The method 500 includes performing exfoliation at step 510. Exfoliation is performed such that the clay mineral material becomes clay mineral flakes. Exfoliation allows for dispersion of flakes to be created as interlayers of the clay mineral material are expanded. In various embodiments, liquid phase exfoliation is conducted to exfoliate the clay mineral material. Liquid phase exfoliation includes refluxing the material with at least one salt solution (e.g., sodium chloride, lithium chloride, etc.). In various embodiments, step 510 includes agitation (e.g., sonication) to cause complete exfoliation of the clay mineral material. In various embodiments, exfoliation at step 510 can include step 210 as described herein with reference to process 200.

The method 500 includes providing a pillaring precursor at step 515. The pillaring precursor is configured to create pillared clay such that the end result is a pillared mineral membrane. The pillaring precursor can be the polycation containing aluminum, zirconium, titanium, and other metal cations, among others. In various embodiments, the pillaring precursor is synthesized. The pillaring precursor is added (e.g., via crosslinking) to the exfoliated clay mineral flakes and agitated. In various embodiments, providing the pillaring precursor at step 515 can occur as described with reference to step 215 of process 200.

The method 500 includes restacking flakes with pillaring precursor to form the membrane at step 520. A membrane-forming process occurs to form the membrane at step 520. The membrane includes at least two phyllosilicate layers with the pillaring precursor disposed therebetween. For example, vacuum filtration, blade coating, slot-die casting, and other processes can occur. In various embodiments, the resultant membrane is an intercalated laminar clay mineral membrane. In various embodiments, providing restacking the flakes at step 520 make include at least some of step 215 as described herein with reference to process 200.

The method 500 also includes calcinating the membrane at step 525. Calcinating the membrane at step 525 allows for conversion of the pillaring precursors to pillars. Calcination allows for the covalent bonds between the clay mineral layers to be formed as metal oxide pillars are formed from the intercalated precursors. The usage of covalent bonds between the clay mineral flakes improves usage and long-term stability in comparison to other approaches (e.g., electrostatic interactions). The calcination process forms the resultant laminar pillared clay mineral membrane. In various embodiments, calcinating the membrane at step 525 make include step 220 as described herein with reference to process 200.

In various embodiments, the method 500 can also include other modification approached for the pillared clay mineral membrane. For example, a dopant cation can be added to the clay mineral and/or the pillaring precursor to further optimize the resultant pillared clay mineral membrane. In other embodiments, the membrane can be functionalized with organic molecules that bind to the pillars or layers and place functional groups within the transport channels that can interact with solutes. As described herein, adding the dopant cation can occur at a number of steps in the method 500. For example, the dopant cation can be added before calcinating the membrane at step 525. In another, the dopant cation can after performing exfoliation at step 510.

Experimental results were obtained to illustrate feasibility of methods and systems (e.g., the process 200, the process shown in FIG. 4, method 500) for forming the pillared clay mineral membranes. Additionally, the experimental results highlight benefits of the pillared clay mineral membrane, which, as discussed herein, include enhanced water stability, tunable membrane charge and pore size, and increased ion selectivity. By way of example, a limited number of combinations of clay mineral and pillaring precursors were used to form the pillared clay mineral membranes. However, a wide range of combinations may be used with the universal methods and systems described herein. Utilizing a wide library of clay minerals and pillaring precursors can improve membrane ion transport selectivity, which enables membrane use in a variety of applications including, but not limited to, resource recovery, energy storage, and water filtration and purification.

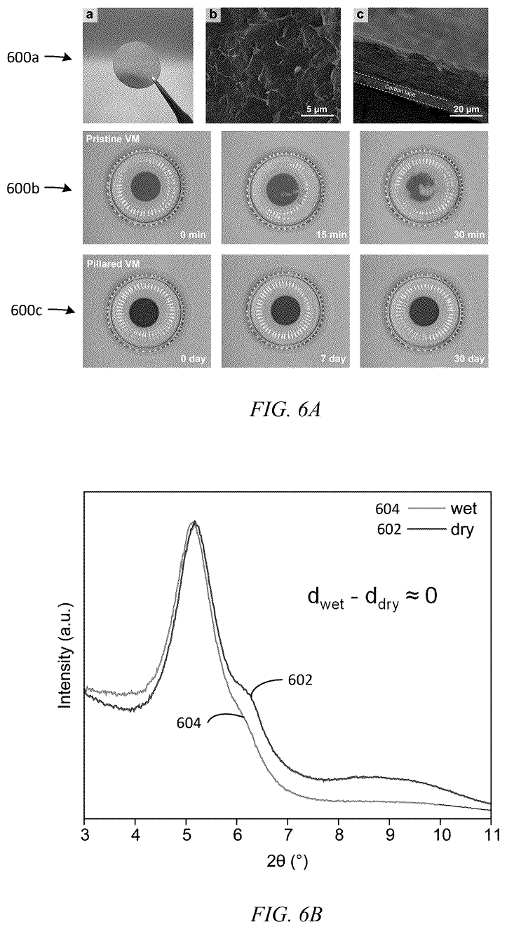

FIGS. 6A and 6B shows results from testing water stability of the pillared clay mineral membrane. FIG. 6A shows images of a membrane that is not pillared, shown in second row 600b, and images of a pillared membrane, shown in third row 600c. The membranes shown in the rows 600b and 600c are vermiculite membranes (VM) with aluminum used as the pillaring precursor. Additionally, the membranes are wet and in an aqueous solution (e.g., a solution of water). A first row 600a of FIG. 6A shows the formed pillared clay mineral membrane of the third row 600c and scanning electron microscope (SEM) images of different views of the membrane. The second row 600b of images shows the vermiculite membrane formed without the pillaring precursor after 0 minutes (mins), 15 mins, and 30 mins in a solution of water. The third row 600c of images shows the vermiculite membrane formed with the pillaring precursor, after 0 days, 7 days, and 30 days in a solution of water. As shown in the images, the pillared vermiculite membrane has greater water stability, which can be seen by the minimal damage of the membrane after the period of time (e.g., after 30 days). In comparison to the membrane without the pillaring precursor (e.g., the second row 600b), which shows damage after 15 mins and more damage after 30 mins, the pillared vermiculite membrane has greater water stability. FIG. 6B shows a graph of interlayer spacing from X-Ray diffraction patterns for a dry pillared vermiculite membrane 602 and a wet pillared vermiculite membrane 604. For the membranes 602, 604, aluminum was used as the pillaring precursor. As can be shown in the graph, the wet pillared membrane 604 has a similar peak location to the dry pillared membrane 602, showing the strong water stability of the pillared clay mineral membrane.

FIG. 7 shows surface charge (using zeta potential as a proxy) of pillared and not pillared vermiculite membrane. As shown in the graph, the vermiculite membrane formed without the pillaring precursor has a negative surface charge and the vermiculite membrane formed with the pillaring precursor aluminum has a zero surface charge. Further modifications to the pillared vermiculite membrane can increase the surface charge, shown with the pillared vermiculite membrane with sodium chloride (NaCl) (e.g., in sodium chloride, treated and/or refluxed with sodium chloride) and the pillared vermiculite membrane doped with sodium (Na). A positive surface charge is favored for multivalent/monovalent cation separation, which is achieved with the pillared vermiculite membrane doped with sodium. The surface charge can be controlled by changing the clay mineral used, the pillaring precursor, and/or whether doping is done, and the cation used for doping.

FIG. 8 shows water permeance of pillared vermiculite membranes. The water permeance is used to compare pore size of pillared vermiculite membrane, by correlating the pore size to the water permeance (e.g., greater water permeance correlated to greater pore size, and vice versa). As shown in the graph, the vermiculite membrane formed with the pillaring precursor aluminum has a greater water permeance correlating to a greater pore size. Further modifications to the pillared vermiculite membrane can change the pore size. As shown in FIG. 8, the pillared vermiculite membrane doped with sodium shows a decrease in water permeance compared to the pillared VM, which correlates to a reduced pore size. The doped pillared vermiculite membrane with sodium chloride demonstrates a further greater decrease in water permeance compared to the doped pillared VM and the pillared VM, which correlates to a reduced pore size. A smaller pore size is favored for monovalent/monovalent cation separation, which is achieved with the sodium-doped pillared vermiculite membranes with and/or without sodium chloride. The pore size can be controlled by changing the clay mineral used, the pillaring precursor, and/or whether doping is done and the cation used for doping.

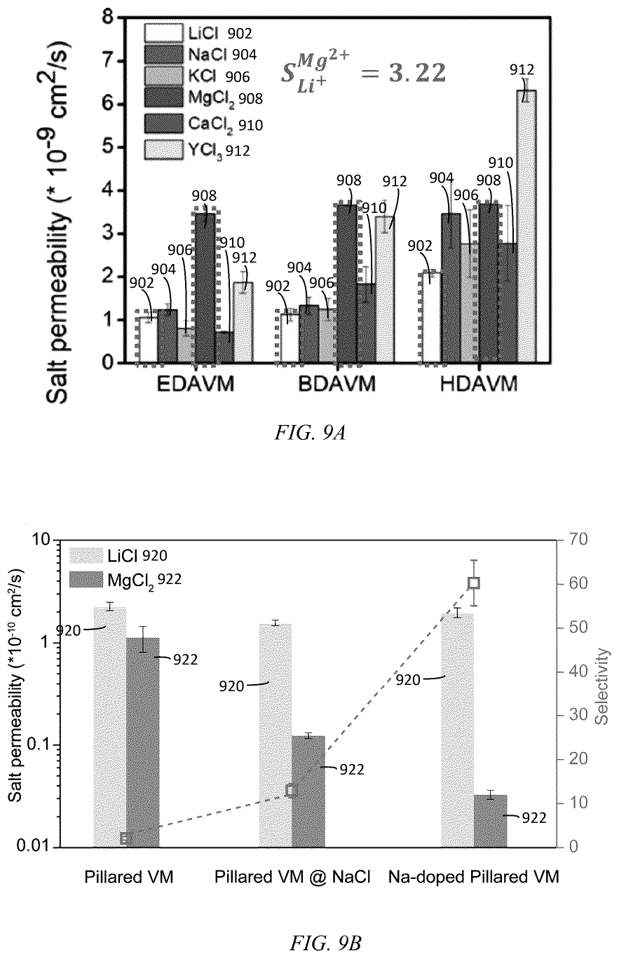

FIGS. 9A and 9B shows salt permeability for crosslinked vermiculite membranes and pillared vermiculite membranes, respectively. The crosslinked vermiculite membranes were crosslinked with diamine. As shown in FIG. 9A, the crosslinked membranes (LiCl 902, NaCl 904, KCl 906, MgCl₂ 908, CaCl₂ 910, YCl₃ 912) were crosslinked using ethyldiamine (“EDAVM”), butanediamine (“BDAVM”), and hexanediamine (“HDAVM”). For the LiCl 902 and MgCl₂ 908, the crosslinked vermiculite membrane showed a lithium and magnesium (Li/Mg) separation of approximately 3.22. In comparison to the crosslinked membranes, pillared membranes demonstrate a greater Li/Mg separation. FIG. 9B shows the pillared membranes LiCl 920 and MgCl₂ 922 as pillared vermiculite membranes, pillared vermiculite membranes with NaCl, and sodium-doped pillared vermiculite membranes. The pillared vermiculite membranes shown in FIG. 9B, especially the doped pillared vermiculite membranes, demonstrate a lower salt permeability and comparable and/or better ion selectivity in comparison to the crosslinked membranes. In comparison to the Li/Mg separation of the crosslinked vermiculite membrane at approximately 3.22, the doped pillared vermiculite membranes show a separation of approximately 60.3 which demonstrates a boosted lithium and magnesium separation. This increase in ion selectivity can enable further applications for the pillared clay mineral membranes, with a potential to further increase ion selectivity with a different combination of clay mineral, pillaring precursor, and dopant cation.

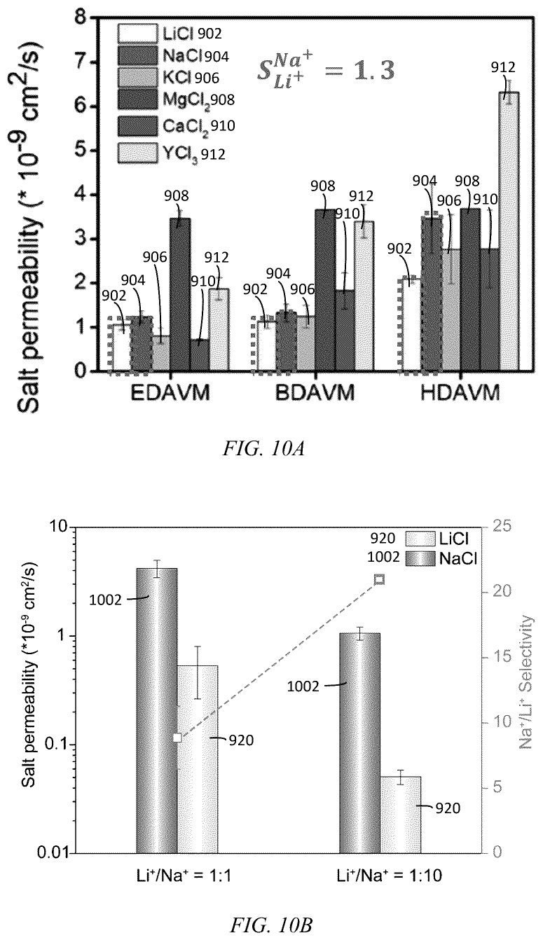

FIGS. 10A and 10B shows salt permeability for the crosslinked vermiculite membranes and the pillared vermiculite membranes, respectively. As shown in FIG. 10A and described with reference to FIG. 9A, the membranes were crosslinked using EDAVM, BDAVM, and HDAVM. FIG. 10B shows the pillared membranes LiCl 920 and NaCl 1002 at a greater pore size (e.g., Li or Na, shown as Li⁺/Na⁺, of 1:1) and a smaller pore size (e.g., Li or Na of 1:10). The pillared vermiculite membranes, especially the pillared vermiculite membranes with the smaller pore size, demonstrated a lower salt permeability and comparable/better ion selectivity for separation between monovalent cations (lithium and sodium in this example). Diamine crosslinked vermiculite membrane showed a sodium and/or lithium (Na/Li) separation of approximately 1.3 while the pillared vermiculite membrane with the greater pore size showed a separation of approximately 10 and the pillared vermiculite membrane with the smaller pore sized showed a separation of approximately 21. This increase in ion selectivity for monovalent cations shows necessary applications for the pillared clay mineral membranes (e.g., lithium extraction for water), with a potential to further increase ion selectivity with a different combination of clay mineral, pillaring precursor, and dopant cation.

Although the examples described in the contexts of FIGS. 6A-10B relate to specific clay mineral and pillaring precursor combinations, the process 200 and the method 500 outlined above can be adapted to provide a pillared clay mineral membrane having one or more target physical and/or chemical characteristics. In various embodiments, the clay mineral used to carry out the method 500 can be selected based on one or more desired physical and/or chemical characteristics (e.g., ion selectivity, salt permeability, water permeability, etc.) of the resultant membrane. In some embodiments, the pillaring precursor can be selected based on one or more desired physical and/or chemical characteristics of the resultant membrane. In some embodiments, the dopant cation can be selected based on one or more desired physical and/or chemical characteristics of the resultant membrane.

Notwithstanding the embodiments described above in FIGS. 1-10B, various modifications and inclusions to those embodiments are contemplated and considered within the scope of the present disclosure.

It is also to be understood that the construction and arrangement of the elements of the systems and methods as shown in the representative embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed.

Accordingly, all such modifications are intended to be included within the scope of the present disclosure. Any means-plus-function clause is intended to cover the structures described herein as performing the recited function and not only structural equivalents but also equivalent structures. Other substitutions, modifications, changes, and omissions may be made in the design, operating conditions, and arrangement of the preferred and other illustrative embodiments without departing from scope of the present disclosure or from the scope of the appended claims.

Furthermore, functions and procedures described above may be performed by specialized equipment designed to perform the particular functions and procedures. The functions may also be performed by general-use equipment that executes commands related to the functions and procedures, or each function and procedure may be performed by a different piece of equipment with one piece of equipment serving as control or with a separate control device.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Similarly, unless otherwise specified, the phrase “based on” should not be construed in a limiting manner and thus should be understood as “based at least in part on.” Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

Moreover, although the figures show a specific order of method operations, the order of the operations may differ from what is depicted. Also, two or more operations may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection operations, processing operations, comparison operations, and decision operations.

What is claimed is:

1. A two-dimensional membrane comprising:
a phyllosilicate material including at least one clay mineral, the phyllosilicate material to form two or more phyllosilicate layers of the membrane, each of the two or more phyllosilicate layers separated by a plurality of pillars; and
the plurality of pillars comprising a metal and bonded to the phyllosilicate material.

2. The membrane of claim 1, wherein the phyllosilicate material is vermiculite.

3. The membrane of claim 1, wherein the plurality of pillars are configured to form covalent bonds with the phyllosilicate material.

4. The membrane of claim 1, wherein the plurality of pillars include a metal oxide pillar.

5. The membrane of claim 1, wherein the metal includes at least one of aluminum, zirconium, or titanium.

6. The membrane of claim 1, further comprising a dopant cation.

7. The membrane of claim 6, wherein the dopant cation is positioned between phyllosilicate layers.

8. The membrane of claim 6, wherein the dopant cation is sodium.

9. The membrane of claim 1, wherein the membrane is positioned in an aqueous solution.

10. A method of producing a two-dimensional membrane, the method comprising:
providing a phyllosilicate material, the phyllosilicate material including a clay mineral;
exfoliating the phyllosilicate material into a plurality of flakes;
combining pillaring precursors with the plurality of flakes, the plurality of flakes restacked with the pillaring precursors to form a membrane comprising at least two phyllosilicate layers with the pillaring precursors disposed therebetween, the phyllosilicate layers including the plurality of flakes; and
converting the pillaring precursors to pillars to form the two-dimensional membrane as a pillared membrane.

11. The method of claim 10, wherein exfoliating the phyllosilicate material includes refluxing the phyllosilicate material with at least one salt solution.

12. The method of claim 10, wherein exfoliating the phyllosilicate material includes agitating the phyllosilicate material.

13. The method of claim 10, wherein converting the pillaring precursors to pillars comprises calcinating the membrane and the pillars are covalently bonded to the phyllosilicate layers.

14. The method of claim 10, wherein:
the method further comprises providing the pillaring precursors prior to combining the pillaring precursors with the plurality of flakes; and
providing the pillaring precursors includes synthesizing the pillaring precursors by adding a base into a salt solution that includes a metal cation.

15. The method of claim 10, wherein restacking the plurality of flakes with the pillaring precursors includes vacuum filtering the plurality of flakes and the pillaring precursors.

16. The method of claim 10, wherein restacking the plurality of flakes with the pillaring precursors includes at least one of slot-die coating or blade coating of the pillaring precursors.

17. The method of claim 10, further comprising adding a dopant cation to the phyllosilicate material prior to calcinating the membrane.

18. The method of claim 10, wherein combining the pillaring precursors with the plurality of flakes further comprises combining a dopant cation with the plurality of flakes.

19. A method of producing a membrane, the method comprising:
exfoliating a phyllosilicate material, the phyllosilicate material including a clay mineral;
combining a pillaring precursor with the exfoliated phyllosilicate material; and
restacking the pillaring precursor with the exfoliated phyllosilicate material to form the membrane, the membrane comprising two phyllosilicate layers with the pillaring precursor disposed therebetween, each of the phyllosilicate layers including the phyllosilicate material.

20. The method of claim 19, further comprising calcinating the membrane to convert the pillaring precursor to a pillar.
